(19) United States
(12) Patent Application Publication
(10) Pub. No.: US 2026/0085705 A1
(43) Pub. Date: Mar. 26, 2026

(54) FLUID PRESSURE CYLINDER

(71) Applicant: KYB Corporation, Tokyo (JP)

(72) Inventor: Norifumi IMAI, Gifu (JP)

(73) Assignee: KYB Corporation, Tokyo (JP)

(21) Appl. No.: 19/109,938

(22) PCT Filed: Oct. 12, 2023
(86) PCT No.: PCT/JP2023/037044

§ 371 Date: Mar. 7, 2025

(30) Foreign Application Priority Data
Oct. 19, 2022 (JP) 2022-167458

(51) Int. Cl. F15B 15/14; F15B 15/22

(52) U.S. Cl. CPC F15B 15/1438; F15B 15/222

(57) ABSTRACT

In a fluid pressure cylinder, a joint portion is formed to have a larger thickness in a radial direction than a main body portion and a connecting portion, an inclination angle of the connecting portion relative to the main body portion is formed so as to be smaller than an inclination angle of a boundary portion between the main body portion and the connecting portion and an inclination angle of a boundary portion between the connecting portion and the joint portion, and the thickness of the connecting portion in the radial direction at an end portion on the joint portion side is formed so as to be larger than the thickness of the main body portion and equal to or smaller than twice the thickness of the main body portion.

### TECHNICAL FIELD

The present invention relates to a fluid pressure cylinder.

### BACKGROUND ART

JPH3-249415A discloses a cylinder device including a cylinder having an opening on one end, a cylinder head that is attached so as to close the opening of the cylinder and that is fixed by a plurality of bolts, a piston rod that is slidably arranged in the cylinder so as to penetrate through the cylinder head, a piston that is attached to the piston rod, and a cushion ring that is attached on the cylinder head side of the piston and that forms a cushioning mechanism together with an inner peripheral portion of the cylinder head.

### SUMMARY OF INVENTION

In the cylinder device as described in JPH3-249415A, the cylinder has a cylindrical main body portion and a joint portion to which the cylinder head is joined. Because the bolts are fastened to the joint portion to fix the cylinder head, the radial thickness of the joint portion is larger than the radial thickness of the main body portion. Thus, in the cylinder, the radial thickness differs between the main body portion and the joint portion. Therefore, for example, when a load is exerted on the cylinder head as the cylinder device is extended and a tensile stress is exerted on the cylinder via the bolts, the stress is concentrated in a vicinity of the boundary between the main body portion and the joint portion of the cylinder, and there is a risk in that the cylinder is damaged.

An object of the present invention is to reduce a stress concentration in a cylinder tube of a fluid pressure cylinder.

According to one aspect of the present invention, a fluid pressure cylinder includes: a cylinder tube; a piston rod provided in the cylinder tube so as to be reciprocatable; a piston connected to the piston rod and slidably received in the cylinder tube; and a cylinder head connected to an opening end of the cylinder tube so as to close the opening end, the cylinder head being configured to form a pressure chamber between the cylinder head and the piston, the cylinder tube has: an annular main body portion; an annular joint portion formed with the opening end and to which the cylinder head is connected; and an annular connecting portion formed so as to extend between the main body portion and the joint portion, the cylinder head is connected to the joint portion of the cylinder tube by a bolt, the joint portion is formed to have a larger thickness in a radial direction than the main body portion and the connecting portion, a boundary portion between the main body portion and the connecting portion and a boundary portion between the connecting portion and the joint portion are formed to have a tapered shape, the connecting portion is formed to have a uniform outer diameter, or the connecting portion is formed such that an outer peripheral surface has the tapered shape in a cross-section of the cylinder tube along a center axis, an inclination angle of the connecting portion relative to the main body portion is formed so as to be smaller than an inclination angle of the boundary portion between the main body portion and the connecting portion and an inclination angle of the boundary portion between the connecting portion and the joint portion, the main body portion, the joint portion, and the connecting portion are formed so as to have a uniform inner diameter, and the thickness of the connecting portion in the radial direction at an end portion on the joint portion side is formed so as to be larger than the thickness of the main body portion and equal to or smaller than twice the thickness of the main body portion.

### BRIEF DESCRIPTION OF DRAWINGS

FIG. 1 is a partial sectional view of a fluid pressure cylinder according to an embodiment of the present invention.

FIG. 2 is a partial sectional view of the fluid pressure cylinder according to the embodiment of the present invention and shows a state in which the fluid pressure cylinder is extended and a piston rod is positioned near a stroke end.

### DESCRIPTION OF EMBODIMENTS

A fluid pressure cylinder according to an embodiment of the present invention will be described with reference to the drawings. In the following, a case in which the fluid pressure cylinder is a hydraulic cylinder 100 that is driven by using a working oil as a working fluid will be described.

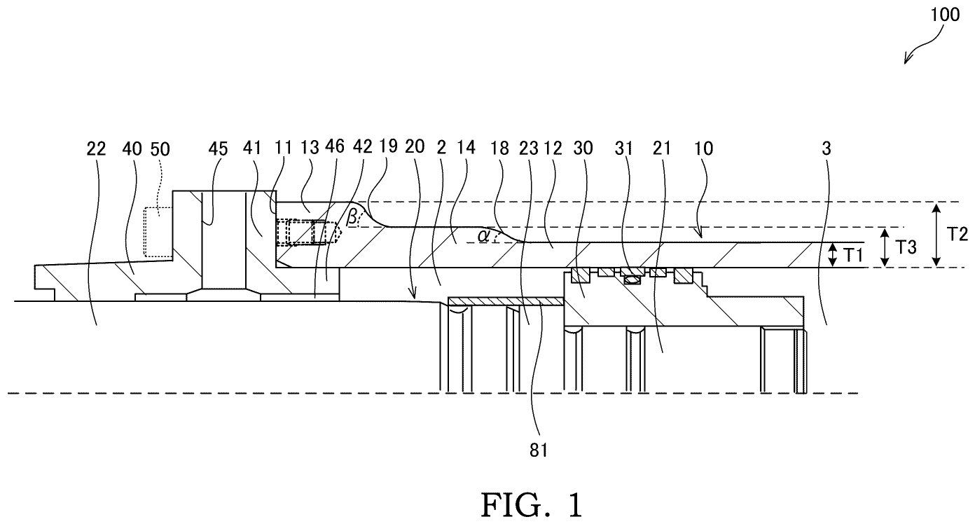

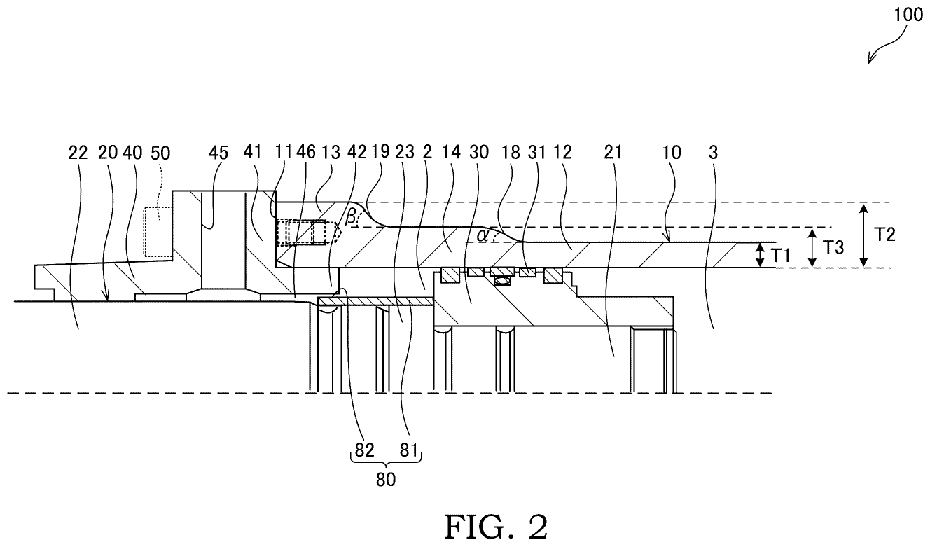

First, the overall configuration of the hydraulic cylinder 100 will be described with reference to FIGS. 1 and 2.

As shown in FIGS. 1 and 2, the hydraulic cylinder 100 includes: a cylinder tube 10; a piston rod 20 that is provided in the cylinder tube 10 so as to be reciprocatable; a piston 30 that is linked to the piston rod 20 and received in the cylinder tube 10 so as to be slidable; and a cylinder head 40 that is connected to an opening end 11 of the cylinder tube 10 so as to close the opening end 11 and that forms a rod side chamber 2 serving as a pressure chamber between the cylinder head 40 and the piston 30.

The cylinder tube 10 is formed to have an annular shape. No reinforcing member, etc. is provided on an outer peripheral surface of the cylinder tube 10. An interior of the cylinder tube 10 is partitioned by the piston 30 into the rod side chamber 2 and an anti-rod side chamber 3. The rod side chamber 2 and the anti-rod side chamber 3 are respectively communicated with a hydraulic pump (not shown) serving as a hydraulic pressure source and a tank (not shown), via a switching valve (not shown). When one of the rod side chamber 2 and the anti-rod side chamber 3 is in communication with the hydraulic pump, the other is in communication with the tank. The hydraulic cylinder 100 is extended and contracted as the working oil (the working fluid) is guided from the hydraulic pump to the rod side chamber 2 or the anti-rod side chamber 3 to cause the piston rod 20 to move in the axial direction. Note that, as the working oil, for example, the working fluid, such as a water-soluble alternative fluid, etc., may also be used instead of oil.

An opening portion of the cylinder tube 10 on the first side (on the left side in FIGS. 1 and 2) is closed by the cylinder head 40, and an opening portion thereof on the second side (on the right side in FIGS. 1 and 2) is closed by a cylinder bottom (not shown). The piston rod 20 is slidably inserted through the cylinder head 40, and thereby, the cylinder head 40 supports the piston rod 20. The cylinder head 40 has a flange portion 41 and a cylindrical portion 42 that is fitted to the inner peripheral surface of the cylinder tube 10. The flange portion 41 is fastened to the cylinder tube 10 by fastening members 50, such as a plurality of bolts, etc. In this embodiment, the cylinder head 40 is connected to the cylinder tube 10 by inserting the fastening members 50 only into a joint portion 13, which will be described later, of the cylinder tube 10. It should be noted that, instead of using the fastening members 50, the cylinder head 40 may be connected to the cylinder tube 10 by, for example, threadedly engaging a threaded portion that is provided on an outer peripheral surface of the cylindrical portion 42 with a threaded portion that is provided on the inner peripheral surface of the cylinder tube 10. The flange portion 41 is formed with a supply and discharge port 45 that extends in the radial direction and that is connected to a hydraulic pipe (not shown). An annular passage 46 that connects the supply and discharge port 45 and the rod side chamber 2 is formed between an outer peripheral surface of the piston rod 20 and an inner peripheral surface of the cylindrical portion 42. The working oil is supplied to and discharged from the rod side chamber 2 through the supply and discharge port 45 and the annular passage 46. The rod side chamber 2 is defined by the cylinder tube 10, the cylinder head 40, and the piston 30, and the anti-rod side chamber 3 is defined by the cylinder tube 10, the cylinder bottom, and the piston 30.

The piston rod 20 has: a small diameter portion 21 that is formed at its tip end portion and to which the piston 30 is linked; a large diameter portion 22 that slides against an inner peripheral surface of the cylinder head 40 and that is formed to have a diameter larger than that of the small diameter portion 21; and a medium diameter portion 23 that is formed between the small diameter portion 21 and the large diameter portion 22 and around which an annular cushion ring 81, which will be described later, is provided. The outer diameter of the medium diameter portion 23 is larger than the outer diameter of the small diameter portion 21 and is smaller than the outer diameter of the large diameter portion 22. The cushion ring 81 is held between the piston 30 and the large diameter portion 22.

The piston 30 is formed to have an annular shape and is connected to the small diameter portion 21 of the piston rod 20. Seal members 31 are provided on the outer peripheral surface of the piston 30. With such a configuration, the communication between the rod side chamber 2 and the anti-rod side chamber 3 through a gap between the inner peripheral surface of the cylinder tube 10 and the outer peripheral surface of the piston 30 is shut off.

When the rod side chamber 2 is in communication with the hydraulic pump and the anti-rod side chamber 3 is in communication with the tank, the working oil is supplied to the rod side chamber 2 through the supply and discharge port 45, and the working oil in the anti-rod side chamber 3 is discharged to the tank. As a result, the piston rod 20 is moved to the right side in FIGS. 1 and 2, and the hydraulic cylinder 100 is contracted.

On the other hand, when the anti-rod side chamber 3 is in communication with the hydraulic pump and the rod side chamber 2 is in communication with the tank, the working oil is supplied to the anti-rod side chamber 3, and the working oil in the rod side chamber 2 is discharged to the tank through the supply and discharge port 45. As a result, the piston rod 20 is moved to the left side in FIGS. 1 and 2, and the hydraulic cylinder 100 is extended.

The hydraulic cylinder 100 further includes a cushioning mechanism 80 (see FIG. 2) that decelerates the piston rod 20 near the stroke end when the working oil in the rod side chamber 2 is discharged and the piston rod 20 is caused to stroke. FIG. 1 shows a state in which the cushioning effect is not generated by the cushioning mechanism 80, and FIG. 2 shows a state in which the hydraulic cylinder 100 is being extended and the cushioning effect is generated by the cushioning mechanism 80.

As shown in FIG. 2, the cushioning mechanism 80 has: the cushion ring 81 that is provided on the medium diameter portion 23 of the piston rod 20 and that enters the annular passage 46 near the stroke end; and a cushion passage 82 that guides the working oil in the rod side chamber 2 to the supply and discharge port 45 when the cushion ring 81 enters the annular passage 46.

The cushion ring 81 is formed to have a diameter larger than the diameter of the large diameter portion 22 of the piston rod 20 and to have a diameter smaller than the diameter of the inner peripheral surface of the cylindrical portion 42 of the cylinder head 40. When the hydraulic cylinder 100 is being extended and the piston rod 20 is positioned in a normal stroke range (not at the stroke end), as shown in FIG. 1, the working oil in the rod side chamber 2 is discharged by being guided to the supply and discharge port 45 through the annular passage 46, which is formed between the outer peripheral surface of the large diameter portion 22 of the piston rod 20 and the inner peripheral surface of the cylindrical portion 42. On the other hand, when the hydraulic cylinder 100 is being extended and the piston rod 20 is positioned near the stroke end, as shown in FIG. 2, the cushion ring 81 having the larger diameter than the large diameter portion 22 enters inside the annular passage 46. Therefore, the working oil in the rod side chamber 2 is discharged by being guided to the supply and discharge port 45 through the cushion passage 82, which is formed between an outer peripheral surface of the cushion ring 81 and the inner peripheral surface of the cylindrical portion 42. Because the flow-passage cross-sectional area of the cushion passage 82 is smaller than that of the annular passage 46, the pressure in the rod side chamber 2 is increased and the piston rod 20 is decelerated. Consequently, the cushioning effect is generated by the cushioning mechanism 80. It should be noted that the configuration of the cushioning mechanism 80 is not limited to that having the cushion ring 81 and the cushion passage 82.

Next, the cylinder tube 10 will be described in detail.

In this embodiment, the cylinder tube 10 is formed of the material having a yield point of 400 MPa or higher, such as S45C thermal refined steel, SM570, SCM430, and so forth, for example. The cylinder tube 10 has an annular main body portion 12, the annular joint portion 13 formed with the opening end 11 and to which the cylinder head 40 is connected, and an annular connecting portion 14 that is formed so as to extend between the main body portion 12 and the joint portion 13. The main body portion 12, the connecting portion 14, and the joint portion 13 are formed continuously, and the cylinder tube 10 is formed to have a uniform inner diameter over the main body portion 12, the connecting portion 14, and the joint portion 13. The main body portion 12, the joint portion 13, and the connecting portion 14 are each formed to have a uniform outer diameter. The boundary portion between the main body portion 12 and the connecting portion 14 and the boundary portion between the connecting portion 14 and the joint portion 13 are each formed to have a tapered shape. In other words, a first tapered portion 18 is formed at the boundary portion between the main body portion 12 and the connecting portion 14, and a second tapered portion 19 is formed at the boundary portion between the connecting portion 14 and the joint portion 13. The axial length of the connecting portion 14 is longer than the axial length of the joint portion 13, and in addition, the axial length of the connecting portion 14 is longer than the axial lengths of the first tapered portion 18 and the second tapered portion 19.

The inclination angle of the connecting portion 14 relative to the main body portion 12 (in this embodiment, the inclination angle is 0 degrees because both of the main body portion 12 and the connecting portion 14 are formed to have the uniform outer diameters) is formed so as to be smaller than the inclination angle a at the boundary portion between the main body portion 12 and the connecting portion 14 and the inclination angle β at the boundary portion between the connecting portion 14 and the joint portion 13. In addition, the inclination angle of the joint portion 13 relative to the main body portion 12 (in this embodiment, the inclination angle is 0 degrees because both of the main body portion 12 and the joint portion 13 are formed to have the uniform outer diameters) is formed so as to be smaller than the inclination angle a and the inclination angle β described above.

Here, the radial thickness dimensions of the main body portion 12, the joint portion 13, and the connecting portion 14 are denoted by T1, T2, and T3, respectively. The joint portion 13 is formed to have the thickness T2 that is larger than the thickness T1 of the main body portion 12 and the thickness T3 of the connecting portion 14 such that the fastening members 50 can be fastened. The connecting portion 14 is formed to have the thickness T3 that is larger than the thickness T1 of the main body portion 12. In other words, in the cylinder tube 10, the outer diameter is largest in the order of the joint portion 13, the connecting portion 14, and the main body portion 12. Specifically, the connecting portion 14 is formed such that the thickness T3 is equal to or smaller than twice the thickness T1 of the main body portion 12. Furthermore, the connecting portion 14 is formed such that the thickness T3 is equal to or smaller than ⅔ times the thickness T2 of the joint portion 13.

In the hydraulic cylinder 100, when the piston 30 and the piston rod 20 are moved to the left side in FIGS. 1 and 2 during the hydraulic cylinder 100 is being extended, a load is exerted to the cylindrical portion 42 of the cylinder head 40. As a result, the load is exerted to the cylinder head 40 toward the left side in FIGS. 1 and 2. Because the cylinder head 40 is connected to the joint portion 13 of the cylinder tube 10 by the fastening members 50, when such a load is exerted to the cylinder head 40, a tensile stress is exerted to the cylinder tube 10 via the fastening members 50. If the hydraulic cylinder 100 has a configuration in which the cylinder tube 10 does not have the connecting portion 14, the difference between the thickness T1 of the main body portion 12 and the thickness T2 of the joint portion 13 is large, and so, there is a risk in that the stress is concentrated in a vicinity of the boundary portion between the main body portion 12 and the joint portion 13, and the cylinder tube 10 is damaged.

However, in the hydraulic cylinder 100, as described above, the cylinder tube 10 has the connecting portion 14, and the thickness T3 of the connecting portion 14 is smaller than the thickness T2 of the joint portion 13 and larger than the thickness T1 of the main body portion 12. Thus, compared with a case in which the connecting portion 14 is not formed, the thickness of the cylinder tube 10 in the radial direction is changed gradually. Therefore, even if the tensile stress is exerted to the cylinder tube 10, the stress concentration in the cylinder tube 10 is reduced. Thus, the damage of the cylinder tube 10 is prevented. Furthermore, as described above, the cylinder tube 10 is formed such that the thickness T3 of the connecting portion 14 is equal to or smaller than twice the thickness T1 of the main body portion 12. Thus, in the cylinder tube 10, the difference between the thickness T1 of the main body portion 12 and the thickness T3 of the connecting portion 14 is small. Therefore, the stress concentration caused between the connecting portion 14 and the main body portion 12, which has the smallest radial thickness and tends to have lower strength, is reduced. As described above, by reducing the stress concentration caused between the connecting portion 14 and the main body portion 12, at which the radial thickness is the smallest, more than the stress concentration caused between the connecting portion 14 and the joint portion 13, at which the radial thickness is the largest, the damage of the cylinder tube 10 is more effectively prevented.

In other words, in this embodiment, it is possible to control the stress concentration caused between the main body portion 12 and the connecting portion 14 and the stress concentration caused between the joint portion 13 and the connecting portion 14 by not only forming the connecting portion 14 to make the change in the wall thickness gradual, but also by adjusting the wall thickness of the connecting portion 14, instead of reducing the stress concentration by simply forming a tapered portion between the main body portion 12 and the joint portion 13, which have different wall thicknesses (the radial thicknesses) from each other. Specifically, as described above, by reducing the stress concentration caused between the main body portion 12 and the connecting portion 14 more than the stress concentration caused between the joint portion 13 and the connecting portion 14, the damage of the cylinder tube 10 is more effectively prevented.

In addition, in this embodiment, the cylinder tube 10 has the connecting portion 14, and the length of the connecting portion 14 in the axial direction is longer than the length of the joint portion 13 in the axial direction. Thus, the cylinder tube 10 has the configuration in which the cylinder tube 10 has two stages of the connecting portion 14 and the joint portion 13 and the change in the wall thickness is gradual, and so, compared with the configuration without the connecting portion 14 or the configuration in which the axial length of the connecting portion 14 is short, the stress concentration caused in the cylinder tube 10 is reduced.

Furthermore, in this embodiment, the inclination angle a at the boundary portion between the main body portion 12 and the connecting portion 14 is formed so as to be smaller than the inclination angle β at the boundary portion between the connecting portion 14 and the joint portion 13. Specifically, the boundary portion between the main body portion 12 and the connecting portion 14 and the boundary portion between the connecting portion 14 and the joint portion 13 are formed to have the tapered shape. The inclination angle a is an acute angle formed between the extension line of the main body portion 12 and the boundary between the main body portion 12 and the connecting portion 14, and the inclination angle β is an acute angle formed between the extension line of the connecting portion 14 and the boundary between the connecting portion 14 and the joint portion 13. With such a configuration, the stress concentration caused between the connecting portion 14 and the main body portion 12, at which the radial thickness is the smallest, is reduced more than the stress concentration caused between the connecting portion 14 and the joint portion 13, at which the radial thickness is the largest.

In addition, in this embodiment, as shown in FIG. 2, the connecting portion 14 is formed so as to face the rod side chamber 2 when the piston rod 20 is decelerated by the cushioning mechanism 80. Thus, when the piston rod 20 is decelerated by the cushioning mechanism 80, the cushion pressure (the high pressure in the rod side chamber 2 when the cushioning effect is being generated) is exerted to the connecting portion 14. Therefore, the connecting portion 14 is required to have a certain strength. In other words, from the viewpoint of the strength, it is preferable that the connecting portion 14 have a large thickness T3.

However, as described above, the connecting portion 14 is formed to have the thickness T3 that is equal to or smaller than ⅔ times the thickness T2 of the joint portion 13. This is made possible because the cylinder tube 10 is formed of a high-strength material with a yield point of 400 MPa or higher as described above, and even if the thickness T3 of the connecting portion 14 is small, it is possible to ensure the strength of the connecting portion 14. As a result, the thickness T3 of the connecting portion 14 becomes small, and so, it is possible to reduce the amount of the material used for the cylinder tube 10. Thus, it is possible to reduce the stress concentration in the cylinder tube 10 and to reduce the amount of the material used for the manufacture of the cylinder tube 10 while ensuring the strength of the cylinder tube 10.

According to the embodiment mentioned above, the operational advantages described below are afforded.

In the hydraulic cylinder 100, the cylinder tube 10 has the connecting portion 14, which is formed between the main body portion 12 and the joint portion 13, and the thickness T3 of the connecting portion 14 is smaller than the thickness T2 of the joint portion 13 and larger than the thickness T1 of the main body portion 12. Thus, in the cylinder tube 10, the change in the radial thickness is gradual, and so, even if the tensile stress is exerted to the cylinder tube 10, the stress concentration is reduced. Furthermore, in the cylinder tube 10, the connecting portion 14 is formed such that the thickness T3 is equal to or smaller than twice the thickness T1 of the main body portion 12. Thus, in the cylinder tube 10, the difference between the thickness T1 of the main body portion 12 and the thickness T3 of the connecting portion 14 is small, and so, the stress concentration caused between the connecting portion 14 and the main body portion 12, which has the smallest radial thickness and tends to have lower strength, is reduced.

In the hydraulic cylinder 100, the connecting portion 14 is formed to have the thickness T3 that is equal to or smaller than ⅔ times T2 of the joint portion 13. With such a configuration, the thickness T3 of the connecting portion 14 becomes small, and so, it is possible to reduce the amount of the material used for the cylinder tube 10.

In the hydraulic cylinder 100, because the inclination angle a at the boundary portion between the main body portion 12 and the connecting portion 14 is formed so as to be smaller than the inclination angle β at the boundary portion between the connecting portion 14 and the joint portion 13, the stress concentration caused between the connecting portion 14 and the main body portion 12, at which the radial thickness is the smallest, is further reduced.

In the hydraulic cylinder 100, the cushion pressure is exerted to the connecting portion 14 when the piston rod 20 is decelerated by the cushioning mechanism 80. Because the cylinder tube 10 is formed of the material having a yield point of 400 MPa or higher, even if the thickness T3 of the connecting portion 14 is small, it is possible to ensure the strength of the connecting portion 14. Thus, while ensuring the strength of the cylinder tube 10, it is possible to reduce the stress concentration in the cylinder tube 10 and to reduce the amount of the material used for the cylinder tube 10.

Next, modifications of this embodiment will be described.

### First Modification

In the above-described embodiment, the hydraulic cylinder 100 includes the cushioning mechanism 80. However, the cushioning mechanism 80 is not an essential component, and the hydraulic cylinder 100 may not include the cushioning mechanism 80. Even with such a configuration, similarly to the above-described embodiment, the stress concentration in the cylinder tube 10 is reduced, and the stress concentration caused between the connecting portion 14 and the main body portion 12 having small radial thickness is reduced. In addition, in the configuration in which the hydraulic cylinder 100 does not include the cushioning mechanism 80, the cushion pressure is not exerted to the connecting portion 14, and so, it is not necessarily required for the cylinder tube 10 to be formed of the material having a yield point of 400 MPa or higher. In other words, it is not an essential configuration that the cylinder tube 10 be formed of the material having a yield point of 400 MPa or higher.

### Second Modification

In the above-described embodiment, the connecting portion 14 of the cylinder tube 10 is formed such that T3 is equal to or smaller than ⅔ times T2 of the joint portion 13. With such a configuration, it is possible to reduce the amount of the material used for the manufacture of the cylinder tube 10. However, although the amount of the material used for the manufacture of the cylinder tube 10 is increased, the connecting portion 14 may be formed such that T3 is smaller than T2 of the joint portion 13 and larger than ⅔ times T2 of the joint portion 13. In other words, it is not an essential configuration that the connecting portion 14 is formed such that T3 is equal to or smaller than ⅔ times T2 of the joint portion 13.

### Third Modification

In the above-described embodiment, the connecting portion 14 is formed so as to have the uniform outer diameter. The present invention is not limited thereto, and the connecting portion 14 may be formed such that the outer peripheral surface is formed to have the tapered shape in the cross-section of the cylinder tube 10 along the center axis shown in FIGS. 1 and 2. In this case, the connecting portion 14 is formed such that the radial thickness is smaller at the end portion on the main body portion 12 side and the radial thickness is larger at the end portion on the joint portion 13 side. In addition, the radial thickness T3 of the connecting portion 14 is the largest at the end portion on the joint portion 13 side. In addition, the inclination angle of the connecting portion 14 relative to the main body portion 12 is formed so as to be smaller than the inclination angle a at the boundary portion between the main body portion 12 and the connecting portion 14 and the inclination angle β at the boundary portion between the connecting portion 14 and the joint portion 13. Even with such a configuration, similarly to the above-described embodiment, the stress concentration in the cylinder tube 10 is reduced, and the stress concentration caused between the connecting portion 14 and the main body portion 12, at which the radial thickness is the smallest, is reduced.

In addition, in the above-described embodiment, the joint portion 13 is formed so as to have the uniform outer diameter. The present invention is not limited thereto, and the joint portion 13 may be formed such that the outer peripheral surface is formed to have the tapered shape in the cross-section of the cylinder tube 10 along the center axis shown in FIGS. 1 and 2. In this case, the joint portion 13 is formed such that the radial thickness is smaller at the end portion on the connecting portion 14 side and the radial thickness is larger at the opening end 11. In addition, the radial thickness T2 of the joint portion 13 is the largest at the opening end 11. In addition, the joint portion 13 is formed such that the inclination angle of the joint portion 13 relative to the main body portion 12 is smaller than the inclination angle a and the inclination angle β described above.

The configurations, operations, and effects of the embodiments of the present invention configured as described above will be collectively described.

The hydraulic cylinder 100 serving as the fluid pressure cylinder includes: the cylinder tube 10; the piston rod 20 provided in the cylinder tube 10 so as to be reciprocatable; the piston 30 connected to the piston rod 20 and slidably received in the cylinder tube 10; and the cylinder head 40 connected to the opening end 11 of the cylinder tube 10 so as to close the opening end 11, the cylinder head 40 being configured to form the rod side chamber 2 serving as the pressure chamber between the cylinder head 40 and the piston 30, wherein the cylinder tube 10 has: the annular main body portion 12; the annular joint portion 13 formed with the opening end 11 and to which the cylinder head 40 is connected; and the annular connecting portion 14 formed so as to extend between the main body portion 12 and the joint portion 13, the joint portion 13 is formed to have a larger thickness T2 in the radial direction than the main body portion 12 and the connecting portion 14, and the connecting portion 14 is formed such that the thickness T3 in the radial direction is larger than the thickness of the main body portion 12 in the radial direction and equal to or smaller than twice the thickness of the main body portion 12 in the radial direction.

With this configuration, the cylinder tube 10 has the connecting portion 14, which is formed between the main body portion 12 and the joint portion 13, and the connecting portion 14 has the radial thickness T3 that is smaller than the radial thickness of the joint portion 13 and the radial thickness T3 that is larger than the radial thickness of the main body portion 12. Thus, compared with a case in which the connecting portion 14 is not formed, the thickness of the cylinder tube 10 in the radial direction is changed gradually. Therefore, the stress concentration in the cylinder tube 10 is reduced. Furthermore, in the cylinder tube 10, the radial thickness T3 of the connecting portion 14 is formed so as to be equal to or smaller than twice the radial thickness of the main body portion 12. Thus, in the cylinder tube 10, the difference between the radial thickness T1 of the main body portion 12 and the radial thickness T3 of the connecting portion 14 is small. Therefore, the stress concentration caused between the connecting portion 14 and the main body portion 12, which has the smallest radial thickness and tends to have lower strength, is reduced.

In addition, the connecting portion 14 is formed such that the radial thickness T3 is equal to or smaller than ⅔ times the thickness of the joint portion 13.

With this configuration, because the radial thickness T3 of the connecting portion 14 of the cylinder tube 10 becomes smaller, it is possible to reduce the amount of the material used for the cylinder tube 10.

In addition, in the hydraulic cylinder 100, the inclination angle a at the boundary portion between the main body portion 12 and the connecting portion 14 is formed so as to be smaller than the inclination angle β at the boundary portion between the connecting portion 14 and the joint portion 13.

With this configuration, the stress concentration caused between the connecting portion 14 and the main body portion 12, at which the radial thickness is the smallest, is further reduced.

In addition, in the hydraulic cylinder 100, the length of the connecting portion 14 in the axial direction is longer than the length of the joint portion 13 in the axial direction.

With this configuration, the stress concentration caused in the cylinder tube 10 is reduced.

In addition, the hydraulic cylinder 100 further includes the cushioning mechanism 80 configured to decelerate the piston rod 20 near the stroke end when the working fluid in the rod side chamber 2 is discharged and the piston rod 20 is caused to stroke, wherein the connecting portion 14 is formed so as to face the rod side chamber 2 when the piston rod 20 is decelerated by the cushioning mechanism 80, and the cylinder tube 10 is formed of the material having a yield point of 400 MPa or higher.

With this configuration, the cushion pressure is exerted to the connecting portion 14 of the cylinder tube 10 when the piston rod 20 is decelerated by the cushioning mechanism 80. Therefore, the connecting portion 14 is required to have a certain strength. Because the cylinder tube 10 is formed of the material having a yield point of 400 MPa or higher, even if the radial thickness T3 of the connecting portion 14 is small, it is possible to ensure the strength of the connecting portion 14. Thus, while ensuring the strength of the cylinder tube 10, it is possible to reduce the stress concentration in the cylinder tube 10 and to reduce the amount of the material used for the cylinder tube 10.

Embodiments of the present invention were described above, but the above embodiments are merely examples of applications of the present invention, and the technical scope of the present invention is not limited to the specific constitutions of the above embodiments.

With respect to the above description, the contents of application No. 2022-167458, with a filing date of Oct. 19, 2022 in Japan, are incorporated herein by reference.

1. A fluid pressure cylinder comprising:
a cylinder tube;
a piston rod provided in the cylinder tube so as to be reciprocatable;
a piston connected to the piston rod and slidably received in the cylinder tube; and
a cylinder head connected to an opening end of the cylinder tube so as to close the opening end, the cylinder head being configured to form a pressure chamber between the cylinder head and the piston, wherein
the cylinder tube has:
an annular main body portion;
an annular joint portion formed with the opening end and to which the cylinder head is connected; and
an annular connecting portion formed so as to extend between the main body portion and the joint portion,
the cylinder head is connected to the joint portion of the cylinder tube by a bolt,
the joint portion is formed to have a larger thickness in a radial direction than the main body portion and the connecting portion,
a boundary portion between the main body portion and the connecting portion and a boundary portion between the connecting portion and the joint portion are formed to have a tapered shape,
the connecting portion is formed to have a uniform outer diameter, or the connecting portion is formed such that an outer peripheral surface has the tapered shape in a cross-section of the cylinder tube along a center axis,
an inclination angle of the connecting portion relative to the main body portion is formed so as to be smaller than an inclination angle of the boundary portion between the main body portion and the connecting portion and an inclination angle of the boundary portion between the connecting portion and the joint portion,
the main body portion, the joint portion, and the connecting portion are formed so as to have a uniform inner diameter, and
the thickness of the connecting portion in the radial direction at an end portion on the joint portion side is formed so as to be larger than the thickness of the main body portion and equal to or smaller than twice the thickness of the main body portion.

2. The fluid pressure cylinder according to claim 1, wherein
the connecting portion is formed such that the thickness in the radial direction is equal to or smaller than ⅔ times the thickness of the joint portion.

3. The fluid pressure cylinder according to claim 1, wherein
the inclination angle of the boundary portion between the main body portion and the connecting portion is formed so as to be smaller than the inclination angle of the boundary portion between the connecting portion and the joint portion.

4. The fluid pressure cylinder according to claim 1, wherein
a length of the connecting portion in the axial direction is longer than a length of the joint portion in the axial direction.

5. The fluid pressure cylinder according to claim 1, further comprising
a cushioning mechanism configured to decelerate the piston rod near a stroke end when working fluid in the pressure chamber is discharged and the piston rod is caused to stroke, wherein
the connecting portion is formed to face the pressure chamber when the piston rod is decelerated by the cushioning mechanism, and
the cylinder tube is formed of the material having a yield point of 400 MPa or higher.
